(19) United States
(12) Patent Application Publication
(10) Pub. No.: US 2004/0044958 A1
(43) Pub. Date: Mar. 4, 2004

(54) Systems and methods for inserting a metadata tag in a document

(76) Inventors: John P. Wolf, Eagle, ID (US); James Steven Campbell, Eagle, ID (US)

Correspondence Address: HEWLETT-PACKARD COMPANY, Intellectual Property Administration, P.O. Box 272400, Fort Collins, CO, 80527-2400, US

(21) Appl. No.: 10/229,756

(22) Filed: Aug. 27, 2002

(51) Int. Cl. G06F 17/00

(52) U.S. Cl. 715/513

(57) ABSTRACT

Systems and methods are described herein for scanning a paper document to create an electronic document that is displayed to allow one or more metadata tags to be inserted in the electronic document. Each metadata tag contains metadata that describes the contents of the document. Large volumes of documents can be archived so that a quick search of the documents may be accomplished by searching the metadata tags contained in the documents. The systems and methods described provide a fast and efficient way to enter metadata tags into documents as paper documents are converted to electronic documents. In at least one implementation, computational algorithms may be used to identify specific portions of a document for selective processing and storage.

### TECHNICAL FIELD

This invention generally relates to processing documents with metadata tags. More particularly, the invention relates to inserting metadata tags in documents as the documents are being processed.

### BACKGROUND

Everyday, an untold number of documents are produced that must be preserved so they can be referenced at a later date. These documents may be in the conventional paper form or they may be electronic documents. In fact, as our culture grows increasingly dependent on computer-generated information, it is quite likely that a majority of documentation produced today is in electronic form. Paper documents are frequently scanned so they may be archived in electronic form. The enormous amount of information stored in electronic documents on computer databases is becoming easier to access as the public becomes more and more familiar with the Internet and with computer research techniques.

To aid in searching through the virtually endless number of documents, metadata tags are sometimes included in electronic documents. Metadata is high-level data that describes lower-level data. In other words, a metadata tag that describes an electronic document can be inserted into the electronic document before the electronic document is stored. A metadata tag in an electronic document usually contains key words and phrases from the document that are likely to be used as search terms for someone who is searching for similar documents. For example, a metadata tag may contain a document title and several words about the subject and/or the author of the document.

That way, when a computerized search engine is directed to search for documents that meet certain requirements, the search engine can more efficiently search the documents by scanning only the metadata tags associated with the documents instead of the entire documents.

Additionally, scanned documents are typically stored as image-only documents that do not comprise searchable text in a stored form. Adding metadata tags to image-only documents provides a way to search many such documents. For example, keywords, profile information, and the like may be stored together with an image-only document to allow one to more easily search for documents of interest and zero in on its content of interest.

Large enterprises that utilize archived electronic databases and computerized search tools use metadata tags to organize large bodies of work. But metadata tags are typically, if not always, entered manually and can be time consuming and expensive. Efficient methods and systems that lower the time and manpower required to insert metadata tags into documents would make such systems more cost beneficial and desirable for certain enterprises.

### SUMMARY

Systems and methods are described herein for inserting metadata tags into electronic documents. For paper documents to be converted to electronic documents, they must go through a scanning process. When a paper document is scanned and converted into an electronic document, a multi-pass image analysis is performed on the electronic digital representation of the scanned document. Then the electronic document is displayed—at least in part—to a user. The user is provided with the capability to enter metadata tags at that time. In one implementation, the metadata tag is defined and inserted by the user when the document is displayed. In another implementation, the user is presented with a list of pre-configured metadata tags. When the user selects a metadata tag from the list, the selected metadata tag is inserted into the electronic document. After the metadata tag is inserted into the electronic document, the electronic document is stored on some type of computer-readable medium.

In another implementation, the document originates as an electronic document and does not have to be converted from a paper document to an electronic document. In such a case, the electronic document is received and is displayed to a user so that the user may insert metadata into the document.

In one or more implementations, computational algorithms are used to locate particular regions of interest in documents. Such regions are automatically detected, bounded and tagged for subsequent specialized processing applicable to the particular region. This saves computational and storage resources because regions of a document have differing OCR and storage requirements as well as meaning to the targeted recipient or repository. Some examples of computational algorithms include background color detection, location of text only regions as opposed to pictures, location of meaningful symbols or shapes, locating barcodes, locating patterns invisible to the naked eye, etc.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 is a block diagram of an exemplary document processing system.

FIG. 2 is a flow diagram depicting a methodological implementation of the document processing system shown in FIG. 1.

FIG. 3 is a block diagram of an exemplary scanner.

FIG. 4 is flow diagram depicting a methodological implementation of the scanner shown in FIG. 3.

### DETAILED DESCRIPTION

The following description sets forth one or more specific implementations and/or embodiments of systems and methods for inserting metadata tags into electronic documents. The systems and methods incorporate elements recited in the appended claims. These implementations are described with specificity in order to meet statutory written description, enablement, and best-mode requirements. However, the description itself is not intended to limit the scope of the present invention.

Also described herein are one or more exemplary implementations of systems and methods for inserting metadata tags into electronic documents. Applicant intends these exemplary implementations to be examples only. Applicant does not intend these exemplary implementations to limit the scope of the claimed present invention. Rather, Applicant has contemplated that the claimed present invention might also be embodied and implemented in other ways, in conjunction with other present or future technologies.

Computer-Executable Instructions

An implementation of a system and/or method for inserting metadata tags into electronic documents is presented and may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Computer-Readable Media

An implementation of a system and/or method for inserting metadata tags into electronic documents may be stored on or transmitted across some form of computer-readable media. Computer-readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communications media” typically embodies computer-readable instructions, data structures, program modules, or other data in a modulated data signal, such as carrier wave or other transport mechanism. Communication media also includes any information delivery media.

Exemplary Document Processing System

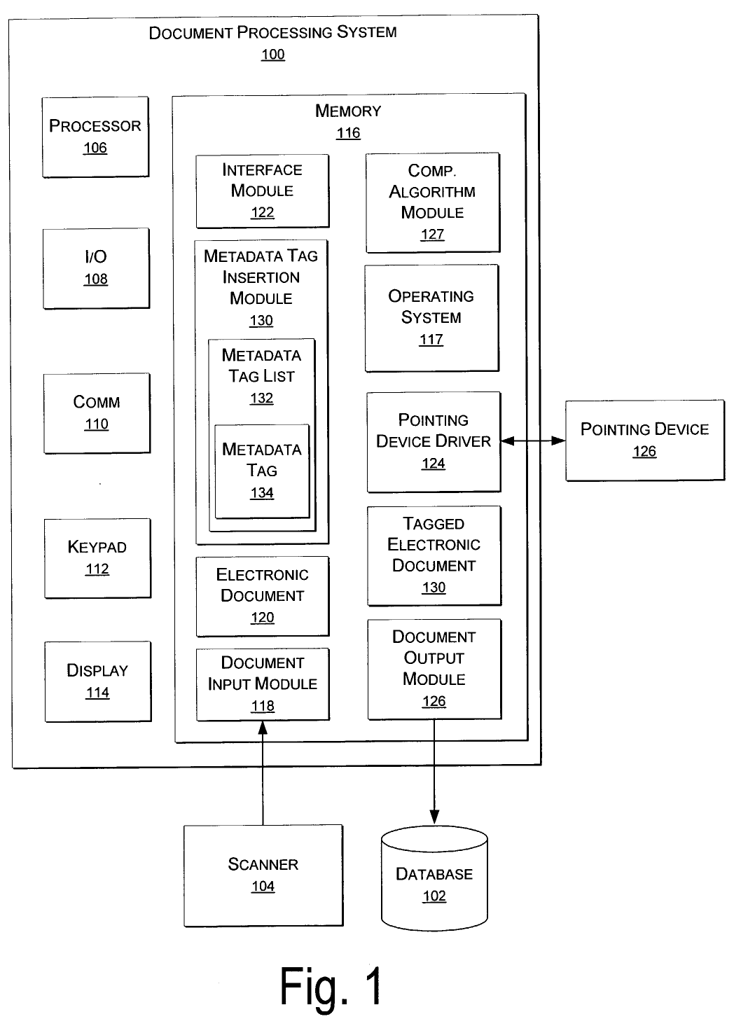

FIG. 1 is a block diagram of an exemplary document processing system 100 constructed in accordance with an implementation of the present invention. The document processing system 100 is shown in conjunction with a database 102 and a scanner 104, though it is noted that the document processing system 100 may be incorporated into a scanner in other implementations that will be described below.

The document processing system 100 includes a processor 106 and an input/output (I/O) module 108 that handles transfer of electronic data to and from the document processing system 100. The document processing system 100 also includes a communications module 110 that allows the document processing system 100 to communicate with other electronic devices via a network, the Internet, etc., a keypad 112 through which character data can be entered into the document processing system 100, and a display 114.

The document processing system 100 includes memory 116, which stores electronic data, including an operating system 117 that controls the function of the document processing system 100. A document input module 118 is stored in the memory 116 and is configured to receive an electronic document 120 from the scanner 104 or by some other method. An interface module 122 is stored in the memory 116 and presents the electronic document 120 on the display 114.

The memory 116 also stores a pointing device driver 124 that controls commands and data received from and sent to a pointing device 126. The pointing device 126 may be any known device used to indicate a position 7 such as a cursor position—in the electronic document, such as a mouse, a stylus, a trackball, a touchpad, etc. If the pointing device 126 is a stylus, it is noted that the display 114 must be a touch screen that is responsive to indications made with the stylus.

The memory 116 also includes a computational algorithm module 127 that may be used to automatically determine portions of one or more of the scanned documents that are tagged for specialized processing to follow. The computational algorithm module 127 may also be programmed to apply a context sensitive algorithm to a scanned document or a set of scanned documents. Some examples of such algorithms include, but are not limited to, the following.

A background color detection algorithm identifies one or more portions of a document that have a particular background and scans only those portions. An algorithm that identifies locations of text only regions only scans portions of the document containing text and disregards pictures or figures. An algorithm that locates meaningful symbols or shapes only scans portions of a document that contain pre-identified symbols or shapes. A barcode algorithm locates and scans barcodes contained in a document while ignoring other portions of the document. An algorithm can locate patterns that are invisible to the naked eye and scan document areas in which those patterns are found.

A document output module 128 is stored in the memory 116 and is configured to output selected portions of the electronic document 120 to the database 102. It is noted that, in the present example, that either the database 102 and/or the scanner 104 is optional. The scanner 104 may not be required if the electronic document 120 is received in electronic form. Also, the database 102 may not be required if the electronic document 120 has some other destination, such as removable magnetic media, a network, etc. In the following discussion, those skilled in the art will recognize that different embodiments of the invention may be implemented depending on the document processing that is required.

A metadata tag insertion module 130 is stored in the memory 116 and is configured to insert a metadata tag into the electronic document 120. A metadata tag list 132 is included in the metadata tag insertion module 130 and stores one or more pre-configured metadata tags 134 for selection during the metadata tag insertion process. The pre-configured metadata tags 134 may be pre-configured to describe different types of standard documents. For example, if several documents are expected to relate to a similar subject matter, a metadata tag can be created for the subject matter so that the metadata tag does not have to be created each time the metadata tag 134 is desired to be inserted into the electronic document 120. Instead, a user can simply select the pre-configured metadata tag 134 from the metadata tag list 130 for insertion into the electronic document 120.

A paper document (not shown) is processed by the scanner 104 to create the electronic document 120. Alternatively, the electronic document 120 may be input to the document processing system 100 in an electronic format via the communications module 110 or the I/O module 108. Once the electronic document 120 has been received by the document processing system 100, the interface module 122 displays at least a portion of the electronic document 120 on the display 114. Typically, the portion of the electronic document 120 displayed will be one page of the electronic document 120, the page size depending on the size of the display. However, only a portion of a document page may be selected as described above.

The pointing device 126 is utilized to indicate a position in the electronic document 120, for example, for a cursor location. The implementation of the position indicating may be any method known in the art, such as with a stylus and touch screen, a mouse, etc. For purposes of discussion, it is assumed that indication of a location in the electronic document 120 is accomplished by using a stylus to communicate with a touch screen display.

Once the position has been identified to insert a metadata tag, the metadata tag is inserted into the electronic document. This may be done by one of several ways. When the position is selected, a pop-up menu of predefined tags may provide tags from which the user may choose to insert into the document. Or a prompt may be displayed, at which point the user enters text to be associated with the tag.

After the metadata tag 134 is inserted into the electronic document 120, it may be stored separately as a tagged electronic document 136. The tagged electronic document 136 will typically be in the form of the electronic document 120 with the additional metadata contained in the metadata tag 134.

When the tagging process is complete, the tagged electronic document 136 may be transmitted to another location. In the present example, the document output module 128 prepares the tagged electronic document 136 for transmission. As previously stated, the electronic document 120 may be stored in the database 102 or sent to another location over a network, stored on removable magnetic media, etc.

Methodological Implementation: Document Processing System

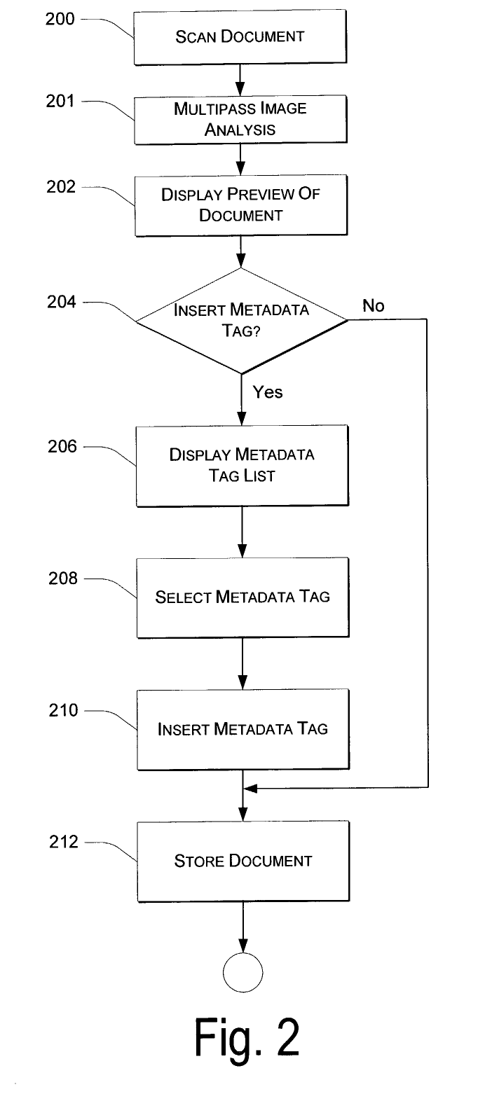

FIG. 2 is a flow diagram depicting a methodological implementation of the exemplary document processing system 100 shown in FIG. 1. Continuing reference will be made to the elements and reference numerals of FIG. 1 in the following discussion of FIG. 2.

At block 200, a document is scanned to create an electronic document. Alternatively, the electronic document 120 may be input to the document processing system 100 in an electronic format via the communications module 110 or the I/O module 108. At block 201, a multi-pass image analysis is performed wherein one or more portions of the electronic document are selected. The one or more portions may be identified by the computational algorithm module 127, may be accomplished manually, or the entire document may be selected for multi-pass image analysis. In addition to tasks specifically defined herein, the multi-pass image analysis process is also used to perform the task of automatically adding or embellishing metadata tags that can be manually edited or deleted or left intact by a user later in the process, i.e., in the steps outlined below.

Once the electronic document 120 has been received by the document processing system 100, the interface module 122 displays at least a portion of the electronic document 120—a document preview—on the display 114 at block 202. Typically, the portion of the electronic document 120 displayed will be one page of the electronic document 120, the page size depending on the size of the display.

At block 204, a decision is made whether a metadata tag 134 needs to be inserted into the electronic document 120. If no metadata tag 134 is required (“No” branch, block 204), then the document is stored (or transferred) at block 212. If a metadata tag 134 should be inserted into the electronic document 120 (“Yes” branch, block 204), then the process continues at block 206.

The metadata tag list 132 is displayed at block 206 and includes the metadata tag 134. The pointing device 126 is utilized to select the metadata tag 134 and to identify a location in the electronic document 120 where the metadata tag 134 is to be inserted (block 208). Metadata tags can be embedded in the original scanned document in such a way to not interfere with documents presentation or tags can be stored in a separate but associated file. At block 210, the metadata tag 134 is inserted into the electronic document 120 to create the tagged electronic document 136.

In one implementation, the metadata tag list 132 is not required. Rather, a user may define the metadata tag 134 at the time it is inserted into the electronic document 130 using the keypad 112.

After the electronic document 120 is tagged, it may be stored in the database 102. As previously discussed, instead of storing the tagged electronic document 136 in the database 102, the tagged electronic document 136 may be transmitted to another location.

Exemplary Scanner

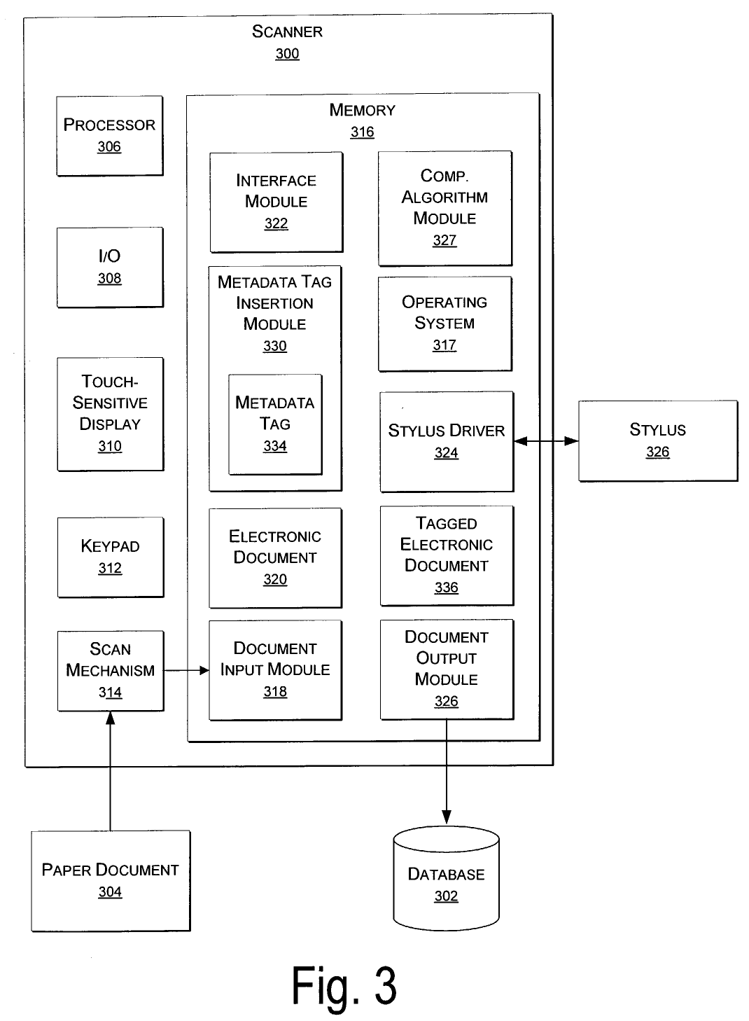

FIG. 3 is a block diagram of an exemplary scanner 300 constructed in accordance with an implementation of the present invention. The scanner 300 is shown in conjunction with a database 302, though the database 302 is optional. A paper document 304 is shown for input into the scanner 300.

The scanner 300 includes a processor 306 and an input/output (I/O) module 308 that handles transfer of electronic data to and from the scanner 300. The scanner 300 also includes a touch-sensitive display 310 that is responsive to touch inputs from a user, a keypad 312 through which character data can be entered into the document processing system 300, and a scan mechanism 314 that is used to scan the paper document 304.

The scanner 300 includes memory 316, which stores electronic data, including an operating system 317 that controls the function of the scanner 300. A document input module 318 is stored in the memory 316 and is configured to receive an electronic document 320 from the scan mechanism 314. An interface module 322 is stored in the memory 316 and presents the electronic document 320 on the display 310.

The memory 316 also stores a stylus driver 324 that controls commands and data received from and sent to a stylus 326. The stylus 326 is used in conjunction with the touch-sensitive display 310, which is responsive to indications made with the stylus 326.

A computational algorithm module 327 is also included in the memory 316. The computational algorithm module 327 may be used to automatically determine portions of one or more documents to be scanned. The computational algorithm module 127 may be programmed to apply a context sensitive algorithm to a scanned document or a set of scanned documents. Some examples of such algorithms include, but are not limited to, detecting and selecting particular background color detection, locating and selecting text only regions as opposed to pictures, locating and selecting meaningful symbols or shapes, locating and selecting barcodes, locating and selecting patterns invisible to the naked eye, etc.

A document output module 328 is stored in the memory 316 and is configured to output selected portions of the electronic document 320 to the database 302. It is noted that, in the present example, that the database 302 is optional. The database 302 may not be required if the electronic document 320 has some other destination, such as removable magnetic media, a network, etc. In the following discussion, those skilled in the art will recognize that different embodiments of the invention may be implemented depending on the document processing that is required.

A metadata tag insertion module 330 is stored in the memory 316 and is configured to insert a metadata tag 332 into the electronic document 320 to create a tagged electronic document 336 by allowing a position to be indicated with the stylus 326 and receiving input from the keypad 312 to define the metadata tag 332.

The paper document 304 is processed by the scanner 300 to create the electronic document 320. Alternatively, the electronic document 320 may be input to the scanner 300 in an electronic format via the communications module I/O module 308. Once the electronic document 320 has been received by the document input module 318, the interface module 322 displays at least a portion of the electronic document 320 on the touch-sensitive display 310. Typically, the portion of the electronic document 320 displayed will be one page of the electronic document 320, the page size depending on the size of the display.

The stylus 326 is utilized to indicate a position in the electronic document 320, for example, for a cursor location. After the metadata tag 334 is defined and inserted into the electronic document 320, it may be stored separately as the tagged electronic document 336. The tagged electronic document 336 will typically be in the form of the electronic document 320 with the additional metadata contained in the metadata tag 334.

When the tagging process is complete, the tagged electronic document 336 may be transmitted to another location. In the present example, the document output module 328 prepares the tagged electronic document 336 for transmission. As previously stated, the electronic document 320 may be stored in the database 302 or sent to another location over a network, stored on removable magnetic media, etc.

Methodological Implementation: Scanner

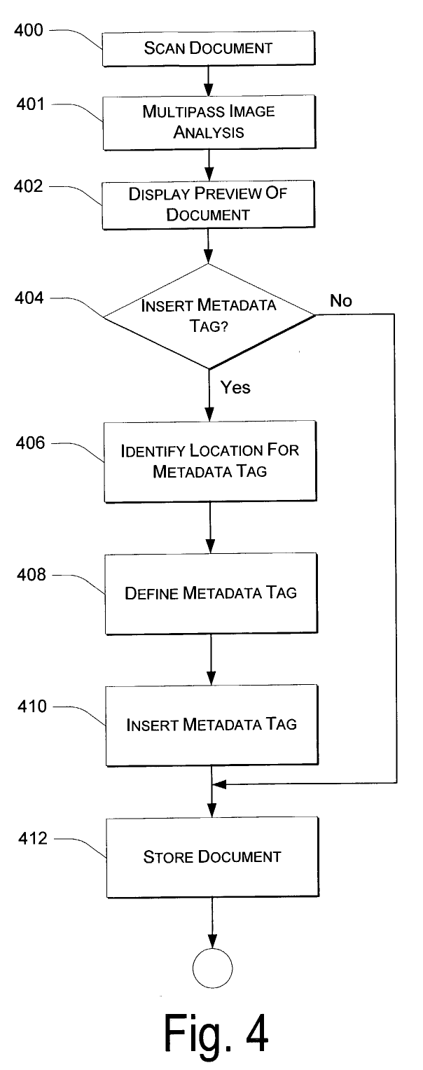

FIG. 4 is a flow diagram depicting a methodological implementation of the exemplary scanner 300 shown in FIG. 3. Continuing reference will be made to the elements and reference numerals of FIG. 3 in the following discussion of FIG. 4.

At block 400, a document is scanned to create an electronic document. Alternatively, the electronic document 320 may be input to the scanner 300 in an electronic format via the I/O module 308. At block 401, a multi-pass image analysis is performed wherein one or more portions of the electronic document 320 are selected. The multi-pass image analysis 401, using the computational algorithm module 327, identifies and selects one or more portions of the document for metadata tag augmentation and population. This process can be accomplished manually in Block 402, display and preview of document, or the entire document may be processed requiring no computation algorithms of this type.

Once the electronic document 320 has been received by the scanner 300, the interface module 322 displays at least a portion of the electronic document 320—a document preview—on the touch-sensitive display 310 at block 402. Typically, the portion of the electronic document 320 displayed will be one page of the electronic document 320, the page size depending on the size of the display.

At block 404, a decision is made whether a metadata tag 334 needs to be inserted into the electronic document 320. If no metadata tag 334 is required (“No” branch, block 404), then the document is stored (or transferred) at block 412. If a metadata tag 334 should be inserted into the electronic document 320 (“Yes” branch, block 404), then the process continues at block 406.

At block 406, a location for the metadata tag 334 is identified using the stylus 326. The keypad 312 is used to enter data to define the metadata tag 334 at block 408. At block 410, the metadata tag 334 is inserted into the electronic document 320 to create the tagged electronic document 336.

After the electronic document 320 is tagged, it may be stored in the database 302. As previously discussed, instead of storing the tagged electronic document 336 in the database 302, the tagged electronic document 336 may be transmitted to another location, that is, a workflow or some variation of a process pipeline.

Conclusion

Implementation of the systems and methods described herein provide efficient ways for inserting metadata tags into electronic documents. While paper documents are being scanned so they can be archived, metadata tags that describe the data contained in the document may be entered into the document. Thereafter, searching documents and other document processing is made more efficient by using the metadata tags.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A scanner, comprising:
a converter configured to convert a paper document into an electronic document;
a display;
an interface module configured to display at least a portion of the electronic document on the display;
a pointing device configured to designate a metadata tag insertion location in the displayed electronic document;
a metadata tag insertion module configured to insert a metadata tag in the electronic document at the designated insertion location to create a tagged electronic document; and
an output module configured to output the tagged electronic document.

2. The scanner as recited in claim 1, wherein:
the metadata tag insertion module further comprises a metadata tag list that contains one or more pre-configured metadata tags; and
a metadata tag is selected from the metadata tag list for insertion in the electronic document.

3. The scanner as recited in claim 1, wherein the metadata tag insertion module is further configured to receive user input to define a metadata tag at the cursor location.

4. The scanner as recited in claim 1, further comprising a computational algorithm module configured to identify and select one or more portions of the electronic document so that portions of the document are selectively processed, presented and stored.

5. The scanner as recited in claim 1, further comprising a keypad which may be used to enter a metadata tag into the electronic document.

6. The scanner as recited in claim 1, wherein the display further comprises a touch-sensitive display that may be used to enter a metadata tag in the electronic document.

7. The scanner as recited in claim 1, wherein:
the pointing device further comprises a stylus; and
the display comprises a touch-sensitive display that is responsive to indications received from the stylus.

8. The scanner as recited in claim 1, wherein the pointing device further comprises a mouse.

9. One or more computer-readable media containing computer-executable instructions that, when executed on a computer, perform the following steps:
receiving an electronic document;
displaying at least a portion of the electronic document on a display;
inserting a metadata tag in the electronic document, thereby creating a tagged electronic document; and
outputting the tagged electronic document.

10. The one or more computer-readable media as recited in claim 9, further comprising the step of receiving an indication of a location where the metadata tag is to be inserted into the electronic document and the step of inserting the metadata tag further comprises inserting the metadata tag at the indicated location.

11. The one or more computer-readable media as recited in claim 9, wherein the step of receiving the electronic document further comprises:
scanning a paper document; and
converting the paper document into an electronic document.

12. The one or more computer-readable media as recited in claim 9, wherein the step of inserting the metadata tag further comprises:
displaying a metadata tag list containing one or more pre-configured metadata tags;
identifying a metadata tag selected from the metadata tag list; and
inserting the selected metadata tag in the electronic document.

13. The one or more computer-readable media as recited in claim 9, wherein the step of outputting the tagged electronic document further comprises storing the tagged electronic document in a computer-readable medium.

14. The one or more computer-readable media as recited in claim 9, wherein the step of inserting the metadata tag further comprises:
receiving an indication of a location to insert a metadata tag;
receiving metadata that defines the metadata tag; and
inserting the defined metadata tag at the indicated location.

15. A method, comprising the steps of:
receiving an electronic document;
displaying at least a portion of the electronic document;
inserting a metadata tag in the electronic document to create a tagged electronic document; and
outputting the tagged electronic document.

16. The method as recited in claim 15, further comprising the step of selecting one or more portions of the electronic document, and wherein only the selected portions are subsequently displayed, tagged and output.

17. The method as recited in claim 15, wherein the step of receiving an electronic document further comprises:
receiving a paper document; and
scanning the paper document to create a corresponding electronic document.

18. The method as recited in claim 15, further comprising the steps of:
displaying a metadata tag list containing one or more metadata tags;
identifying a selected metadata tag from the metadata tag list; and
wherein the selected metadata tag is the metadata tag inserted in the electronic document.

19. The method as recited in claim 15, wherein the step of inserting the metadata tag further comprises:
identifying a location to insert a metadata tag;
receiving metadata to define a metadata tag; and
inserting the defined metadata tag in the electronic document at the identified location.

20. The method as recited in claim 15, wherein the step of outputting the tagged electronic document further comprises storing the tagged electronic document on a computer-readable medium.

21. The method as recited in claim 15, wherein the step of inserting the metadata tag further comprises:
identifying a selected location in the electronic document where a metadata tag is to be inserted;
identifying a metadata tag; and
inserting the identified metadata tag at the selected location.

22. The method as recited in claim 15, wherein the metadata tag further comprises information about the content of the electronic document.

23. A system, comprising:
an input module configured to receive an electronic document;
a display;
a display interface module configured to display at least a portion of the electronic document on the display;
a metadata tag module configured to place a metadata tag at one or more specified locations in the electronic document; and
an output module configured to output the electronic document.

24. The system as recited in claim 23, further comprising a computational algorithm module configured to identify the one or more specified locations in the electronic document.

25. The system as recited in claim 23, further comprising a metadata tag insertion module configured to enable a user to identify the one or more specified locations in the electronic document.

26. The system as recited in claim 23, wherein:
the metadata tag insertion module further comprises a metadata tag list that contains one or more pre-configured metadata tags; and
a metadata tag is selected from the metadata tag list for insertion at the one or more specified locations of the electronic document.

27. The system as recited in claim 1, wherein the display further comprises a touch-sensitive display that may be used to enter a metadata tag in the electronic document.
